(19) United States
(12) Patent Application Publication
(10) Pub. No.: US 2025/0332979 A1
(43) Pub. Date: Oct. 30, 2025

(54) VEHICLE INTERNAL SUPPORT STRUCTURE ASSEMBLY

(71) Applicant: Grounded RVs, Inc., Detroit, MI (US)

(72) Inventors: Matthew Nyrkkanen, Royal Oak, MI (US); Blaine Riley, Detroit, MI (US); Samuel Shapiro, Detroit, MI (US); Nicholas Fitzpatrick, Detroit, MI (US)

(21) Appl. No.: 19/096,149

(22) Filed: Mar. 31, 2025

Related U.S. Application Data
(60) Provisional application No. 63/638,994, filed on Apr. 26, 2024.

(51) Int. Cl. B60P 3/34

(52) U.S. Cl. CPC B60P 3/34

(57) ABSTRACT

A vehicle internal support structure assembly. The assembly includes a first frame structure including a left-side frame portion, a right-side frame portion and a top-side frame portion. The first frame structure is interconnected with the second frame structure. The left-side frame portion includes a first group of interconnected vertically oriented and horizontally oriented longitudinal frame members. The right-side frame portion includes a second group of interconnected vertically oriented and horizontally oriented longitudinal frame members. The top-side frame includes a third group of interconnected longitudinal frame members. The left-side frame is connected to the top-side frame via a first group of connection members. The right-side frame is interconnected to the top-side frame via a second group of connection members.

### CROSS-REFERENCE TO RELATED APPLICATIONS

This application claims the benefit of priority to U.S. Provisional Application No. 63/638,994, filed on Apr. 26, 2024, which is hereby incorporated by reference in its entirety.

### FIELD

The application relates generality to the field of support structures, and more particularly to vehicle internal support structure assembly and methods of manufacture thereof.

### SUMMARY

A vehicle internal support structure assembly. The assembly includes a first frame structure including a left-side frame portion, a right-side frame portion and a top-side frame portion. The first frame structure is interconnected with the second frame structure. The left-side frame portion includes a first group of interconnected vertically oriented and horizontally oriented longitudinal frame members. The right-side frame portion includes a second group of interconnected vertically oriented and horizontally oriented longitudinal frame members. The top-side frame includes a third group of interconnected longitudinal frame members. The left-side frame is connected to the top-side frame via a first group of connection members. The right-side frame is interconnected to the top-side frame via a second group of connection members.

A method of constructing an interior vehicle living space, in particular manufacturing and installing a vehicle internal support structure assembly. In some embodiments, the method includes constructing a vehicle internal support structure assembly with multiple longitudinal frame members interconnected with one another. Insulation panels are added to the exterior sides of the support structure assembly. Electrical wiring is coupled to the support structure assembly.

Wood panels (or panels of other material types) are added to the support structure assembly at rectangular positions formed by intersecting longitudinal frame members. The constructed internal support structure assembly is moved into an interior cargo area of a vehicle. The support structure assembly is securely attached to the interior of the vehicle. Furniture components are attached to the longitudinal frame members of the support structure assembly.

Furthermore, the appended claims may serve as a summary of this application.

### BRIEF DESCRIPTION OF THE DRAWINGS

FIGS. 1A-1E are diagrams illustrating an example vehicle internal support structure assembly.

FIGS. 2A-2B are diagrams illustrating example interconnection of longitudinal member of the vehicle internal support structure assembly.

FIGS. 3A-3B show a partially completed assembly with insulation and wiring attached to the vehicle internal support structure assembly.

FIGS. 4A-4C shows a partially completed assembly with panels attached to the vehicle internal support structure assembly.

FIG. 5 shows an internal view of a completed assembly with componentry attached to the vehicle internal support structure assembly.

FIG. 6 shows an internal view of a completed assembly with componentry attached to the vehicle internal support structure assembly.

FIG. 7 shows an internal view of a completed assembly with componentry attached to the vehicle internal support structure assembly.

FIG. 8 is a flowchart illustrating a method 800 of constructing an interior vehicle living space, in particular manufacturing and installing a vehicle internal support structure assembly.

FIG. 9 is a flowchart illustrating a method 900 for selecting furniture modules to be added to the internal support structure assembly.

FIG. 10 is a user interface depicting the selection of furniture modules added to the internal support structure assembly.

FIG. 11 is a diagram illustrating an exemplary computer that may perform processing in some embodiments.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially.

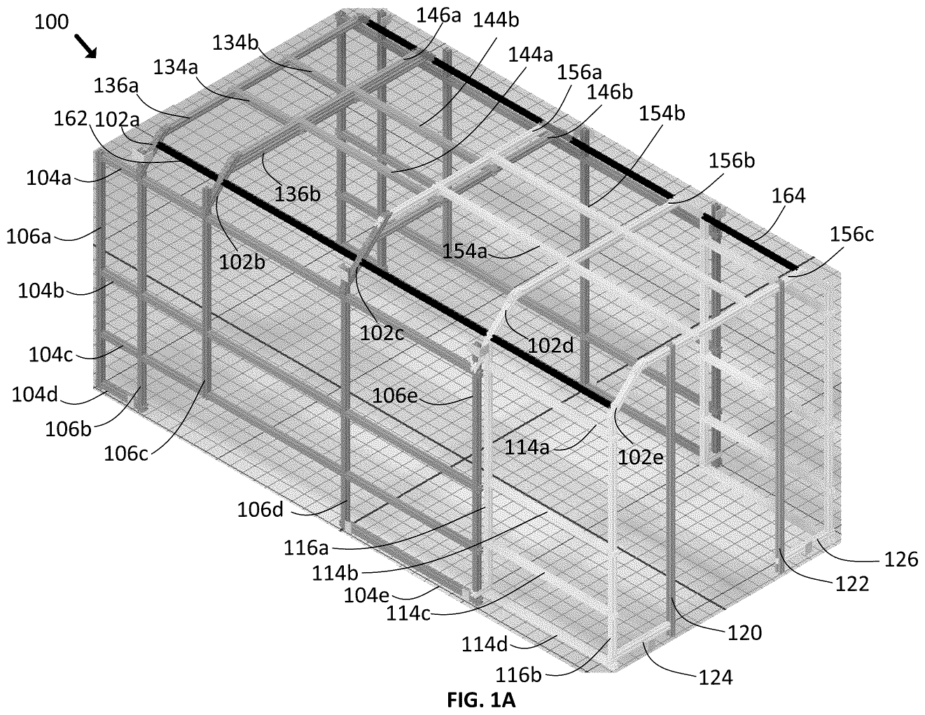

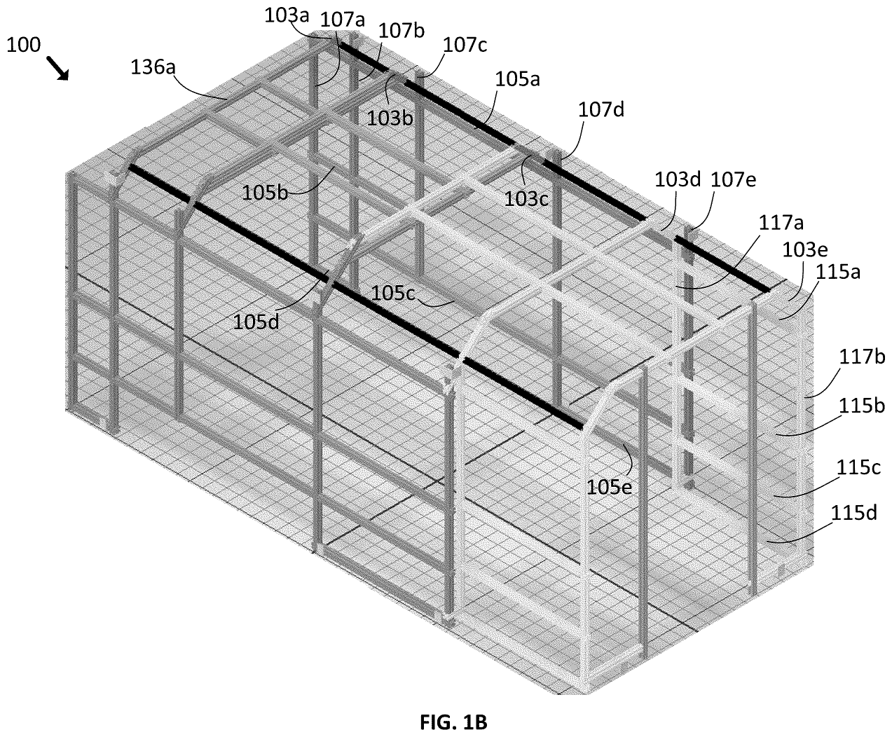

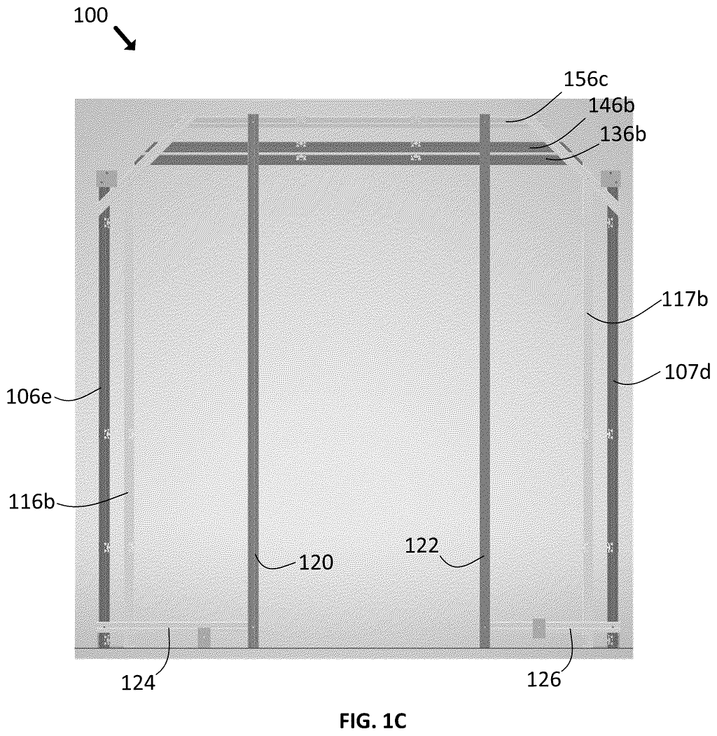

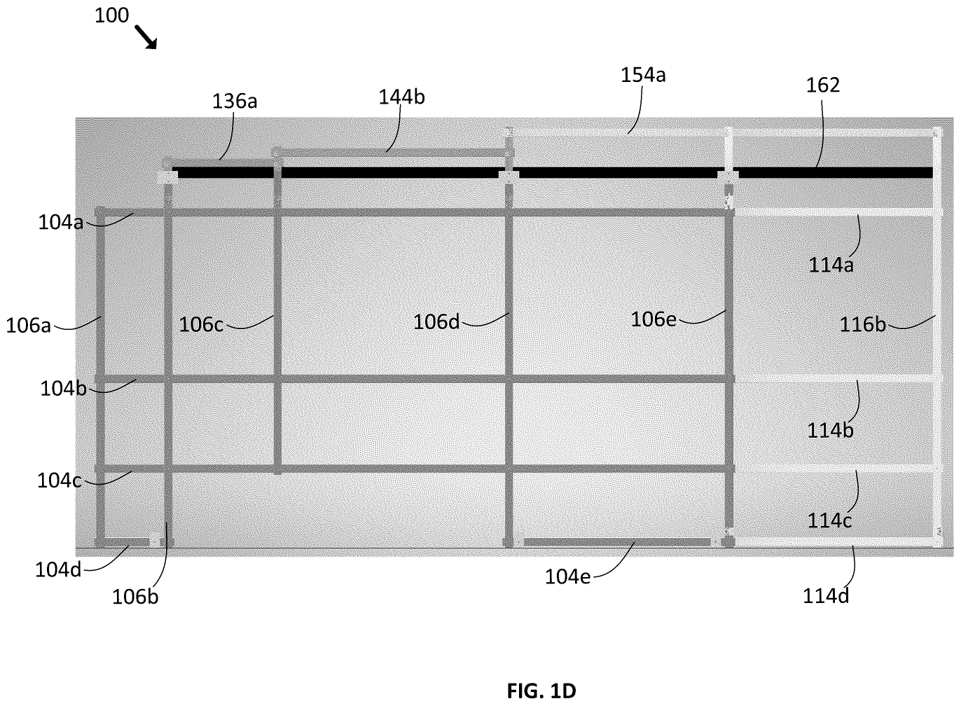

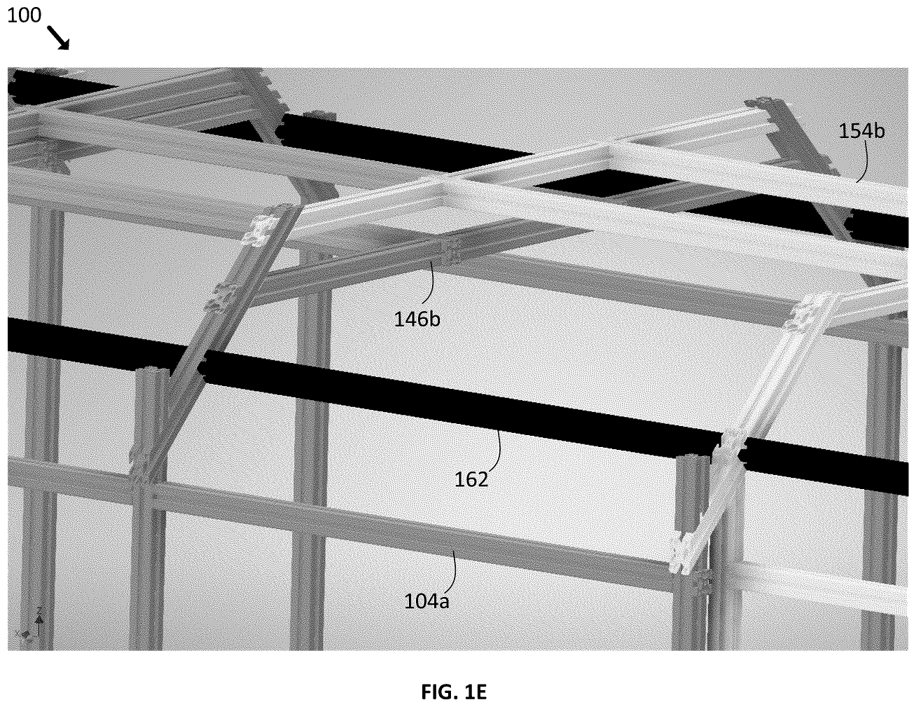

FIGS. 1A-1E are diagrams illustrating an example vehicle internal support structure assembly. In some embodiments, the vehicle internal support structure assembly 100 comprises a first frame structure. FIG. 1A and FIG. 1B are the same figures with labeling indicating various longitudinal frame members and components of the support structure assembly. FIG. 1C is a front view of the vehicle internal support structure assembly 100. FIG. 1D is a left view of the vehicle internal support structure assembly 100. FIG. 1E is a top 3D perspective close-up view of the vehicle internal support structure assembly.

### First Frame Structure

The first frame structure comprises a left-side frame portion, a right-side frame portion and a top-side frame portion. The left-side portion of the first frame structure includes a first group of interconnected horizontally oriented longitudinal frame members 104a, 104b 104c, 104d, 104e and vertically oriented longitudinal frame members 106a, 106b, 106c 106d, 106e. In some embodiments, more horizontally oriented longitudinal frame members may be added or some removed. In some embodiments, more vertically oriented longitudinal frame members may be added or some removed.

The right-side portion of the first frame structure includes a second group of horizontally oriented longitudinal frame members 105a, 105b 105c, 105d 105e and interconnected vertically oriented longitudinal frame members 107a, 107b, 107c 107d, 107e. In some embodiments, more horizontally oriented longitudinal frame members may be added or some removed. In some embodiments, more vertically oriented longitudinal frame members may be added or some removed.

The top-side frame portion of the first frame structure includes a third group of interconnected longitudinal frame members 134a, 134b, 136a, 136b and a fourth group of interconnected longitudinal frame members 144a, 144b, 146a, 146b. In some embodiments, the fourth group is positioned vertically higher than the third group, and the longitudinal frame member 146a is positioned above and adjacent to the longitudinal frame member 136b. In some embodiments, more longitudinal frame members may be added.

The top-side frame portion is interconnected with the right-side frame portion and the left-side frame portion. The longitudinal frame members of top-side frame portion 136a, 136b, 146a, 146b are positioned substantially 90 degrees to the right-side frame portion longitudinal frame members 106a, 106b, 106c, 106d, 106e and to the left-side frame portion longitudinal frame members 107a, 107b, 107c, 107d, 107e.

In some embodiments, the top-side frame portion is interconnected with the right-side frame portion and the left-side frame portion via longitudinal connection members. For example, at a first end, longitudinal member 136a is interconnected to longitudinal member 106b via longitudinal connection member 102a. At a second end, longitudinal member 136a is interconnected to longitudinal member 107b via longitudinal connection member 103a. At a first end, longitudinal frame members 146a, 136b are interconnected to longitudinal member 106c via longitudinal connection member 102b. At a second end, longitudinal frame members 146a, 136b are interconnected to longitudinal member 107c via longitudinal connection member 103b. At a first end, longitudinal member 146b is interconnected to longitudinal member 106d via longitudinal connection member 102c. At a second end, longitudinal member 146b is interconnected to longitudinal member 107d via longitudinal connection member 103c.

In some embodiments, the longitudinal connection members are positioned at a 45 degree angle with respect to a horizontally oriented longitudinal member at a first end of the longitudinal connection member and a second end of a vertically oriented longitudinal connection member. However, the longitudinal connection member may be positioned at different angles, such as 30 degrees and 60 degrees, 20 degrees and 70 degrees, etc. such that the two angles of the longitudinal connection member sum to about 90 degrees.

In some embodiments, the positioning of the right-side frame portion longitudinal frame members of the first frame structure is symmetrical to the positioning of the left-side frame portion longitudinal frame members.

### Second Frame Structure

In some embodiments, the vehicle internal support structure assembly 100 comprises a second frame structure interconnected with the first frame structure.

The second frame structure comprises a left-side frame portion, a right-side frame portion and a top-side frame portion. The left-side portion of the second frame structure includes a first group of interconnected horizontally oriented longitudinal frame members 114a, 114b 114c, 114de and vertically oriented longitudinal frame members 116a, 116b. In some embodiments, more horizontally oriented longitudinal frame members may be added or some removed. In some embodiments, more vertically oriented longitudinal frame members may be added or some removed.

The right-side portion of the second frame structure includes a second group of horizontally oriented longitudinal frame members 115a, 115b 115c, 115d and interconnected vertically oriented longitudinal frame members 117a, 117b. In some embodiments, more horizontally oriented longitudinal frame members may be added or some removed. In some embodiments, more vertically oriented longitudinal frame members may be added or some removed.

The top-side frame portion of the second frame structure includes a third group of interconnected longitudinal frame members 156a, 156b, 156c, 154a, 145b. In some embodiments, the third fourth group of the second frame structure is positioned vertically higher than the second group of the first frame structure. In some embodiments, more longitudinal frame members may be added. In some embodiments, the third group of longitudinal frame members of the second frame structure are positioned vertically higher than the fourth group of longitudinal frame members of the fourth group of longitudinal frame members of the first frame structure. In some embodiments, longitudinal member 156a of the second frame structure is positioned above longitudinal member 146a of the first frame structure.

In some embodiments, at a first end, longitudinal frame member 156a is interconnected with longitudinal frame member 106d (of the first frame structure) via longitudinal connection member 102c. At a second end, longitudinal frame member 156a is interconnected with longitudinal frame member 107d (of the first frame structure) via longitudinal connection member 103c.

In some embodiments, longitudinal frame member 156b is interconnected with longitudinal frame member 106e (of the first frame structure) and longitudinal frame member 116a via longitudinal connection member 102d. At a second end, longitudinal frame member 156a is interconnected with longitudinal frame member 107e (of the first frame structure) and longitudinal frame member 117a via longitudinal connection member 103d.

In some embodiments, longitudinal frame member 156c is interconnected with longitudinal frame member 116b via longitudinal connection member 102e. At a second end, longitudinal frame member 156c is interconnected with longitudinal frame member 117b via longitudinal connection member 103e. In some embodiments, longitudinal frame member 156c is interconnected with longitudinal frame members 120, 122.

In some embodiments, the second frame structure includes additional horizontally positioned longitudinal frame members 124, 126 and vertically positioned longitudinal frame members 120, 122.

In some embodiments, longitudinal frame member 162 is interconnected with longitudinal connection members 102a, 102b, 102c, 102d, 102e. In some embodiments, longitudinal frame member 164 is interconnected with longitudinal connection members 103a, 103b, 103c, 103d, 1023. Longitudinal frame members 162, 164 secure the first frame structure and the second frame structure together.

In some embodiments, a distance between the left-side frame portion and the right-side portion of the second structure is smaller than a distance between the left-side frame portion and the right-side portion of the first structure. In other words, the left-side and right-side portions of the second frame structure are positioned closer together than the left-side and right-side portions of the first frame structure.

In some embodiments, the longitudinal frame members of the vehicle internal support structure assembly each have groves or tracks integral to a longitudinal member. The grooves or tracks may be included on or more of the sides of a longitudinal member. The grooves or tracks may run the entire length of a section of a longitudinal member. The grooves or tracks are used to support the attachment of components to the vehicle internal support structure. Attachment pins or mechanisms may be inserted into the grooves or tracks and are moveable along the grooves or tracks. The attachment pins or mechanisms may be tightened to secure the attachment pin or mechanism in place at the groove or track of the longitudinal member.

In some embodiments, the longitudinal frame members may includes a series of holes positioned along the length of the longitudinal member thereby allowing attachment of components to the hole of the longitudinal frame members.

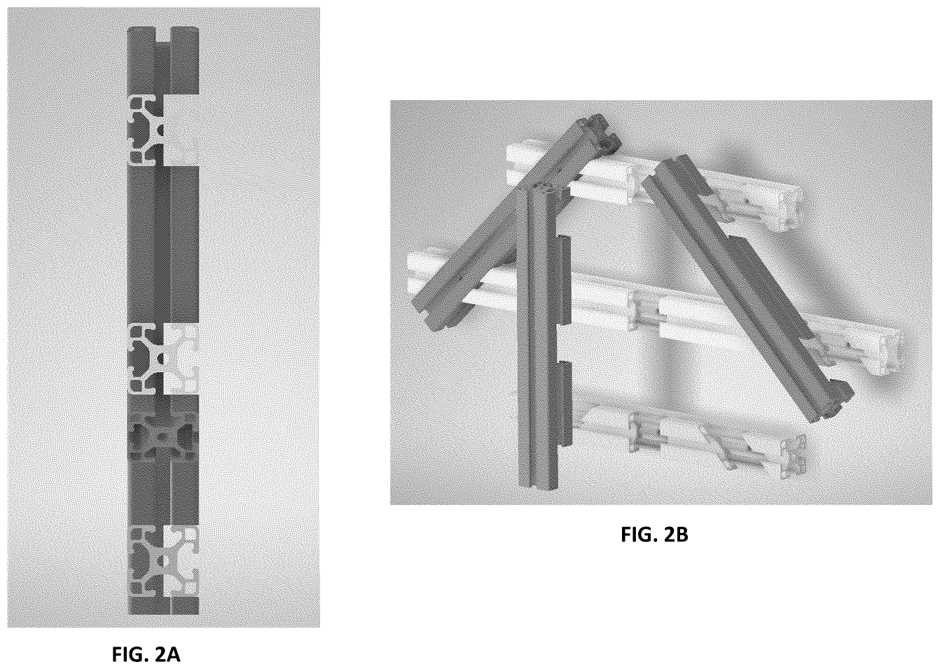

FIGS. 2A-2B are diagrams illustrating example interconnection of longitudinal member of the vehicle internal support structure assembly. FIG. 2A depicts a cross-sectional view of longitudinal frame members interconnected of how longitudinal frame members would be interconnected with respect to FIG. 2B. The longitudinal member may have notches in the longitudinal frame members that provide for connection of the longitudinal frame members together.

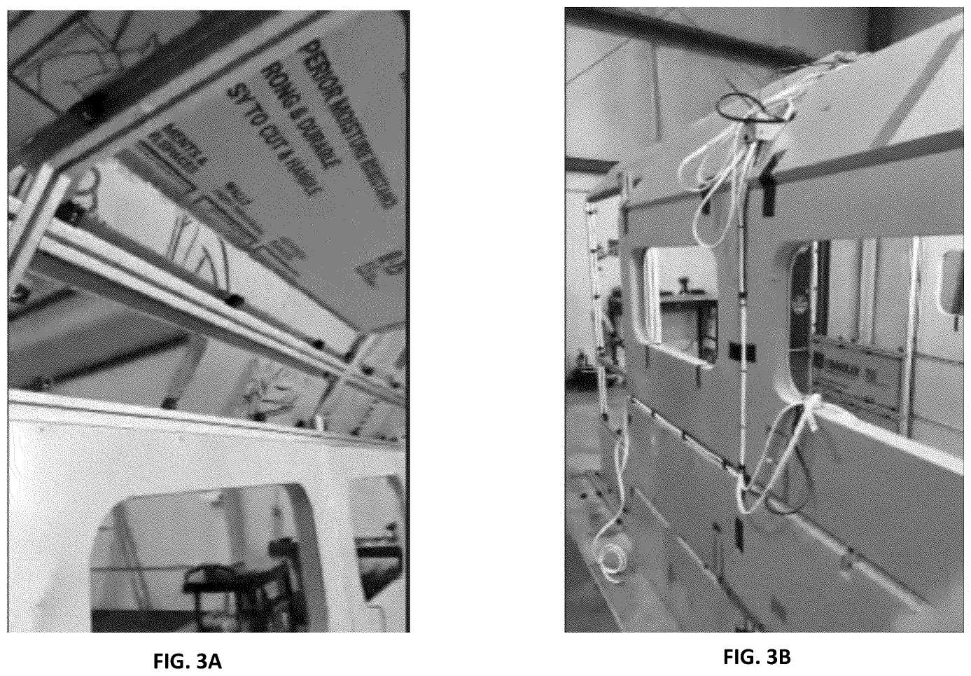

FIGS. 3A-3B show a partially completed assembly with insulation and wiring attached to the vehicle internal support structure assembly. FIG. 3A illustrates an interior view of the vehicle internal support structure assembly 100 with insulation attached to a top portion of the assembly and panels attached to a side portion of the assembly 100. FIG. 3A illustrates an exterior view of the vehicle internal support structure assembly 100 with insulation attached to a top portion of the assembly 100 and to a side portion of the assembly 100. Windows or portals are cut or shaped in the insulation. Also, panels of the insulation attached to the assembly 100 are spaced or positioned onto the assembly 100 in a manner to form channels between the insulation panels.

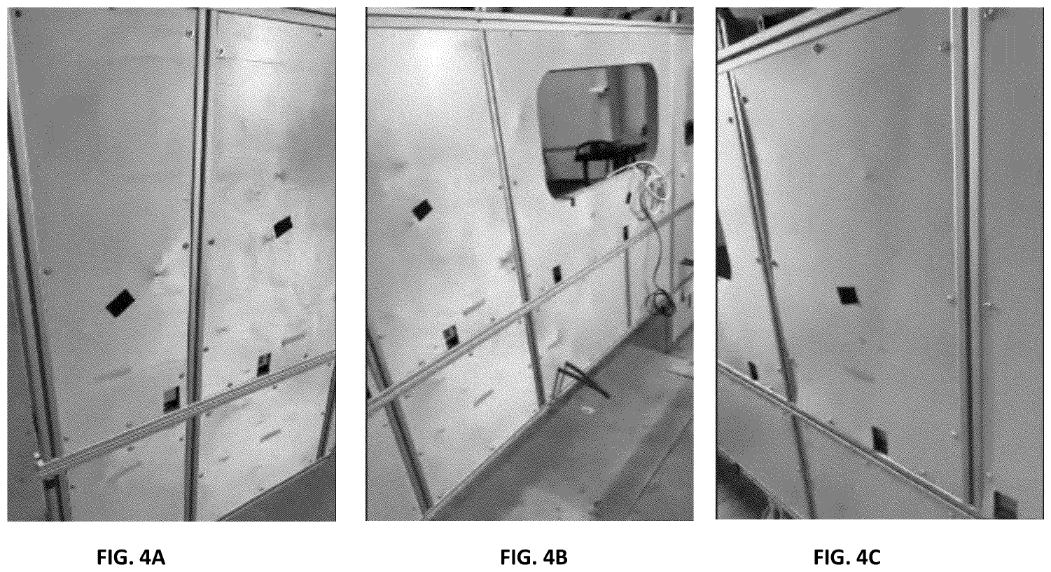

FIGS. 4A-4C shows a partially completed assembly with panels attached to the vehicle internal support structure assembly. In some embodiments, panels such wood panels, or some panels made of some other materials may be positioned between areas forming rectangles between longitudinal frame members. For example, referring to FIG. 1, longitudinal frame members 104a, 106b, 104b, 104c form a rectangle in which a panel may be placed. The panels may be placed and secured at or between the area formed by any of the four longitudinal frame members, especially where they form a rectangular space.

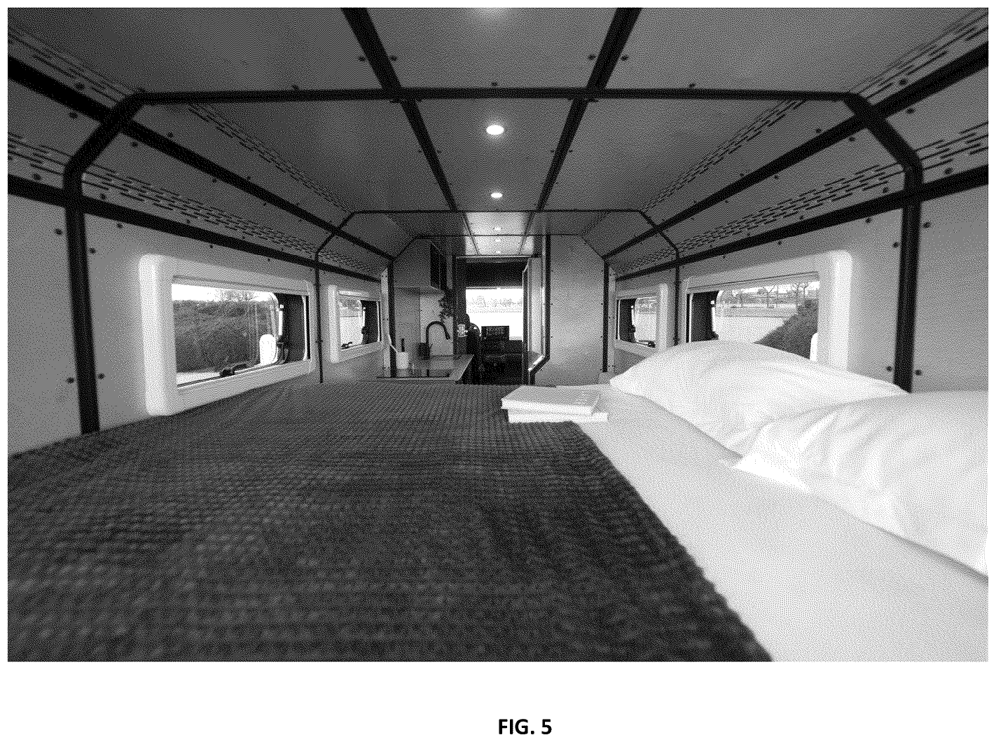

FIG. 5 shows an internal view of a completed assembly with componentry attached to the vehicle internal support structure assembly. FIG. 5 is a rear-to-forward interior view of a completed and assembly 100 with panels and furniture components attached to the assembly 100. The interconnected longitudinal frame members with the internal tracks or grooves are accessible for placement or movement of the furniture components or other accessories.

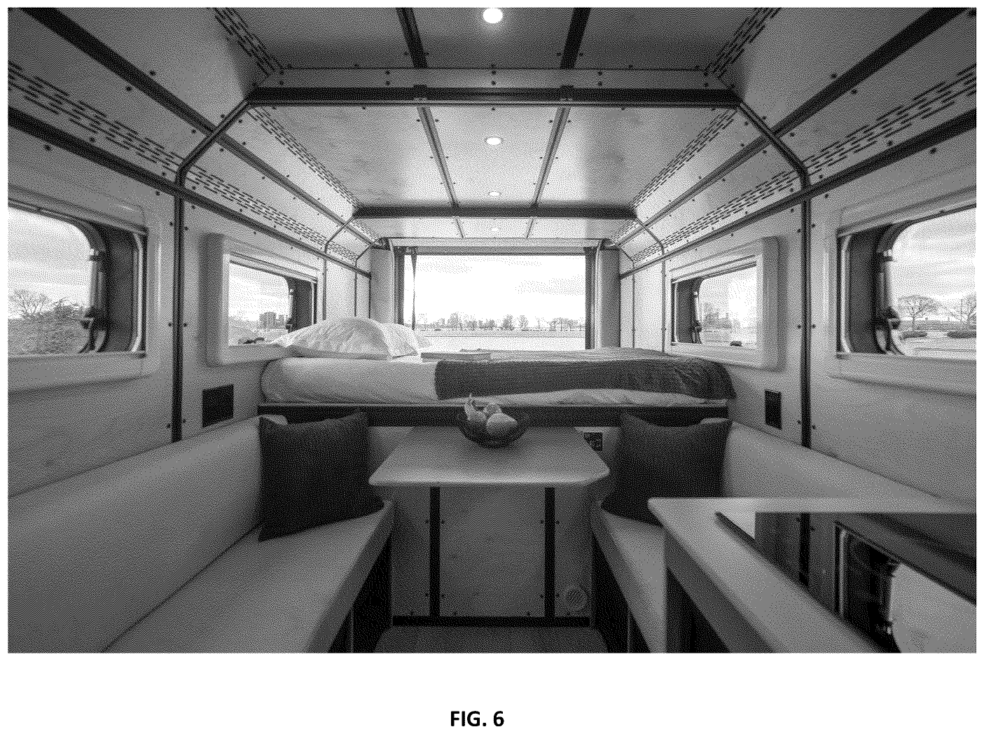

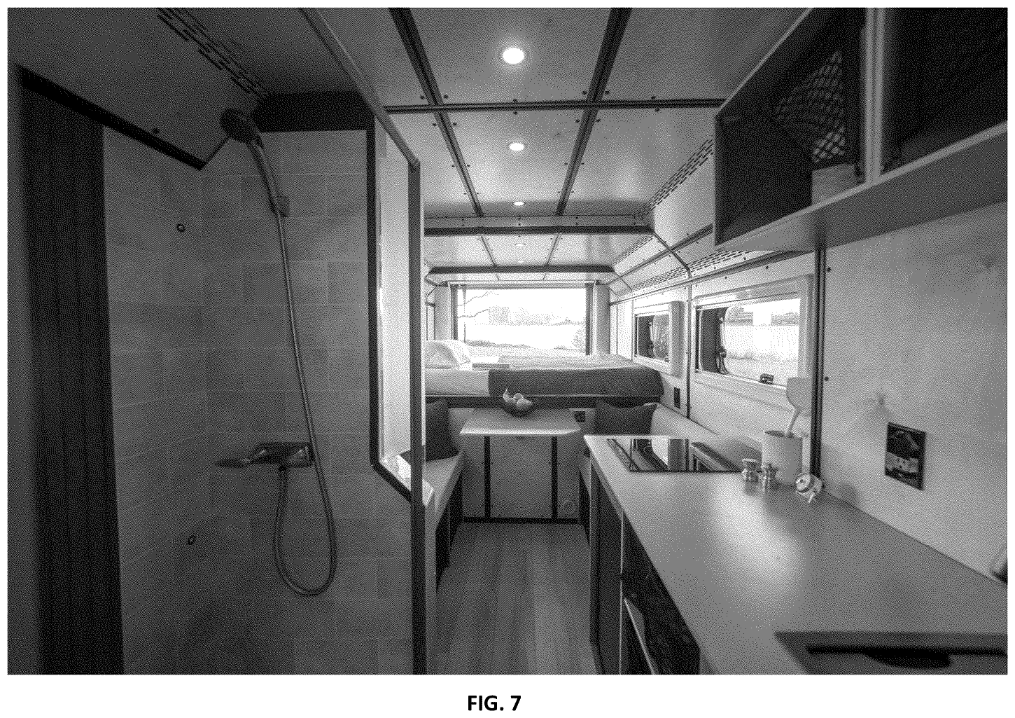

FIG. 6 shows an internal view of a completed assembly with componentry attached to the vehicle internal support structure assembly. FIG. 6 is a forward-to-rear interior view of a completed and assembly 100 with panels and furniture components attached to the assembly 100. The interconnected longitudinal frame members with the internal tracks or grooves are accessible for placement or movement of the furniture components or other accessories.

FIG. 7 shows an internal view of a completed assembly with componentry attached to the vehicle internal support structure assembly. FIG. 7 is a forward-to-rear interior view of a completed and assembly 100 with panels and furniture components attached to the assembly 100. The interconnected longitudinal frame members with the internal tracks or grooves are accessible for placement or movement of the furniture components or other accessories.

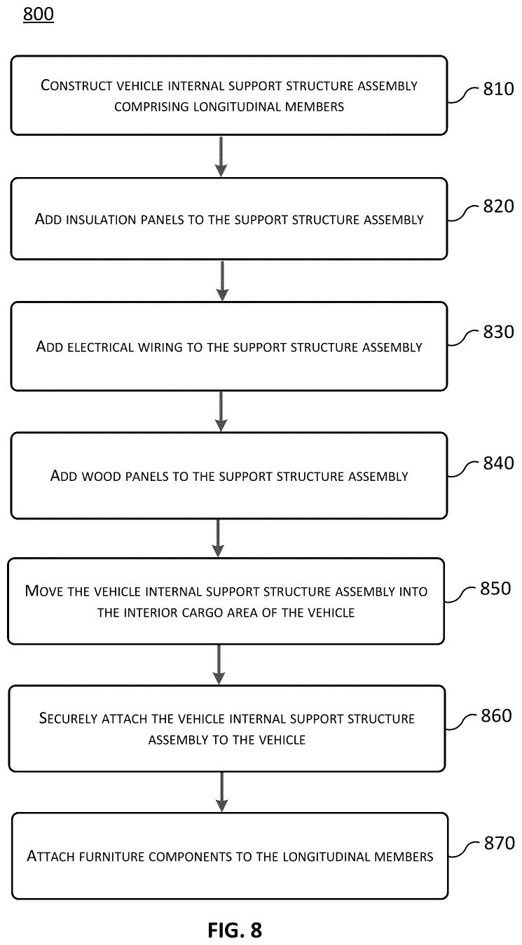

FIG. 8 is a flowchart illustrating a method 800 of constructing an interior vehicle living space, in particular manufacturing and installing a vehicle internal support structure assembly. The vehicle internal support structure assembly is particularly suited for construction and assembly and then placed into a cargo space of a vehicle. For example, the internal support structure assembly 100 may be constructed and assembled and placed into a cargo van or other truck with a open cargo area, such as the GM BrightDrop Zevo vehicle.

At step 810, the vehicle internal support structure assembly 100 is constructed. The longitudinal frame members of the assembly are interconnected with one another.

At step 820, insulation panels are added to the exterior sides of the support structure assembly 100. In some embodiments, the insulation panels are placed onto coupled to the sides and top portions of longitudinal frame members of the support structure assembly. The insulation panels may be placed onto the support structure assembly such that channels are formed between adjacent insulation panels.

At step 830, electrical wiring is coupled to the support structure assembly. The electrical wiring is used to provide electricity to the interior of the support structure assembly. The electrical wiring may be positioned within the channels formed between adjacent insulation panels.

At step 840, wood panels (or panels of other material types) are added to the support structure assembly at rectangular positions formed by intersecting longitudinal frame members.

At step 850, the constructed internal support structure assembly is moved into an interior cargo area of a vehicle. For example, the structure is moved into a rear opening of a van or truck with cargo space. In some exemplary vehicles, the vehicle has a door retractable cargo door that lifts up and move into a top interior portion of the cargo space. In some embodiments, the support structure assembly 100 is configured with multiple levels of top-side ceiling frame portions to accommodate the retraction of the cargo door into the top interior portion of the cargo space.

At step 860, the support structure assembly 100 is securely attached to the vehicle. For example, portions of the longitudinal frame members may be attached directly to the floor and/or interior walls or vehicle structures of the interior cargo space.

At step 870, furniture components are attached to the longitudinal frame members of the support structure assembly 100. For example, support structure assembly 100 allows for the direct attachment to the longitudinal member of the modular furniture and other interior living space components. For example, seating, cabinets, beds, shower stalls, etc. may be coupled directed to the longitudinal frame members. Moreover, the modular components may be positioned at various location using the tracks of the longitudinal frame members.

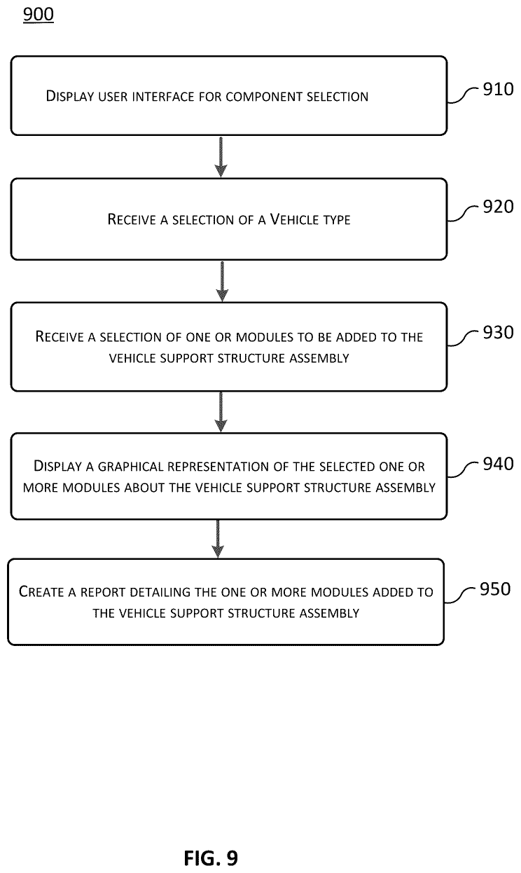

FIG. 9 is a flowchart illustrating a method 900 for selecting furniture modules to be added to the internal support structure assembly. A computer system may generate user interfaces allowing a user to customize and add furniture modules to a graphical representation of the vehicle support structure assembly. A report, CAD drawings, bill of materials and other data may be generated by the system for the selected modules.

In step 910, the system generates a user interface allowing a user to select components to be added to a graphical representation of the vehicle support structure assembly.

In step 920, the user interface may receive a selection of a particular vehicle to add the components to. In response to the selection, a vehicle support structure assembly specific to the selected vehicle is displayed via the user interface.

In step 930, a user may select various modules to be added to the vehicle support structure assembly. Via the user interface, the components may be moved (such as drag and dropped) to various locations about the vehicle support structure assembly. The system stores the location of the added components about the vehicle support structure assembly.

In step 940, the user interface display the added modules about the vehicle support structure assembly. The component configurations may be saved to a data storage devices for later retrieval or display.

In step 950, the system uses the stored component configures to create one or more reports or files detailing the name of the added component and a location of the added component to the vehicle support structure assembly.

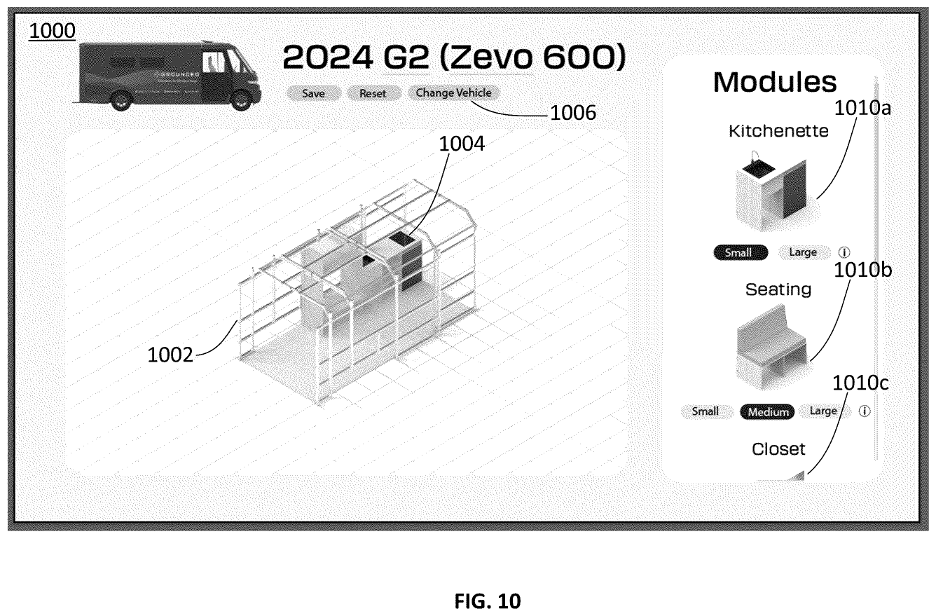

FIG. 10 is a user interface 1000 depicting the selection of furniture modules added to the internal support structure assembly. The vehicle support structure assembly 1002 is graphically represented via the user interface. The user interface may receive a selection 1006 to change the vehicle. In response, to changing to a different vehicle, the system displays a vehicle support structure assembly for the selected vehicle.

The user interface 1000 provides for a component selection section where a user may select one or more components 1010a, 1010b, 1010c to be added to the vehicle support structure assembly. The user interface may automatically determine a placement about the vehicle support structure assembly. For example, certain components may be predefined to be placed at a location about the vehicle support structure assembly. A user may move the component 1004 to a different location about the vehicle support structure assembly. Various components may include different sizes of the component. For example, a Kitchenette may be large or small or a seating component may be small, medium or large. The size of the component relates to the amount of horizontal space the component will use when added to the vehicle support structure assembly.

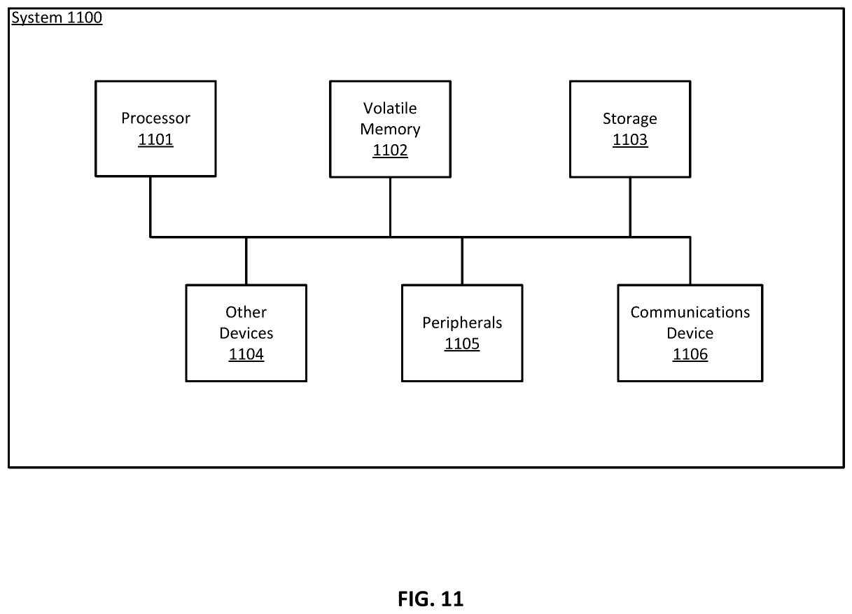

FIG. 11 is a diagram illustrating an exemplary computer that may perform processing in some embodiments. Exemplary computer 1100 may perform operations consistent with some embodiments. The architecture of computer 1100 is exemplary. Computers can be implemented in a variety of other ways. A wide variety of computers can be used in accordance with the embodiments herein.

Processor 1101 may perform computing functions such as running computer programs. The volatile memory 1102 may provide temporary storage of data for the processor 1101. RAM is one kind of volatile memory. Volatile memory typically requires power to maintain its stored information. Storage 1103 provides computer storage for data, instructions, and/or arbitrary information. Non-volatile memory, which can preserve data even when not powered and including disks and flash memory, is an example of storage. Storage 1103 may be organized as a file system, database, or in other ways. Data, instructions, and information may be loaded from storage 1103 into volatile memory 1102 for processing by the processor 1101.

The computer 1100 may include peripherals 1105. Peripherals 1105 may include input peripherals such as a keyboard, mouse, trackball, video camera, microphone, and other input devices. Peripherals 1105 may also include output devices such as a display. Communications device 1106 may connect the computer 1100 to an external medium. For example, communications device 1106 may take the form of a network adapter that provides communications to a network. A computer 1100 may also include a variety of other devices 1104. The various components of the computer 1100 may be connected by a connection medium such as a bus, crossbar, or network.

It will be appreciated that the present disclosure may include any one and up to all of the following examples.

Example 1: A vehicle internal support structure assembly, comprising: a first frame structure comprising: a left-side frame portion comprising: a first group of interconnected vertically oriented and horizontally oriented longitudinal frame members; a right-side frame portion comprising: a second group of interconnected vertically oriented and horizontally oriented longitudinal frame members; and a top-side frame portion comprising: a third group of interconnected longitudinal frame members; wherein the left-side frame is connected to the top-side frame via a first group of connection members, and wherein the right-side frame is interconnected to the top-side frame via a second group of connection members.

Example 2. The vehicle internal support structure assembly of Example 1, further comprising: a second frame structure comprising: a left-side frame comprising: a first group of interconnected vertically oriented and horizontally oriented longitudinal frame members; a right-side frame comprising: a second group of interconnected vertically oriented and horizontally oriented longitudinal frame members; a top-side frame comprising: a third group of interconnected longitudinal frame members; wherein the left frame is connected to the top frame via a first group of connection members, and wherein the right frame is interconnected to the top frame via a second group of connection members.

Example 3. The vehicle internal support structure assembly of one of Examples 1-2, wherein the top-side frame of the second frame structure is positioned higher relative to the top-side frame of the first frame structure.

Example 3. The vehicle internal support structure assembly of one of Examples 1-3, wherein a width of the second frame structure is smaller than a width of the first frame structure, the width of the first frame structure being a distance from the left-side frame and the right-side frame of the first frame structure, and the width of the second frame structure being a distance from left-side frame and the right-side frame of the second frame structure.

Example 4. The vehicle internal support structure assembly of one of Examples 1-4, wherein the first group of interconnected vertical and horizontal longitudinal frame members, includes at least two vertical longitudinal frame members each having a track with one or more slideable track attachments, and at least two horizontal longitudinal frame members each having a track with one or more slideable track attachments.

Example 5. The vehicle internal support structure assembly of one of Examples 1-4, further comprising: a first furniture component coupled to the at least two horizontal longitudinal frame members, the first furniture component being attachable to one or more locations along the track.

Example 6. The vehicle internal support structure assembly of one of Examples 1-5, further comprising: a plurality of panels coupled to the at least two horizontal longitudinal frame members, the plurality of panels being attachable to one or more locations along the track.

Example 7. The vehicle internal support structure assembly of one of Examples 1-6, further comprising: a plurality of panels coupled to the at least two horizontal longitudinal frame members, the plurality of panels being attachable to one or more locations along the track.

Example 8. The vehicle internal support structure assembly of one of Examples 1-7, further comprising: multiple insulation panels attached to the right-side frame portion and/or the left-side frame portion, wherein attached plurality of insulation panels form a channel between the multiple insulation panels; and electrical wiring positioned within the channel.

Example 9. The vehicle internal support structure assembly of one of Examples 1-8, where one or more of the multiple insulation panels include sections forming a portal or window in the insulation panels.

Example 10. The vehicle internal support structure assembly of one of Examples 1-9, further comprising: a plurality of insulation panels attached to the top-side frame portion.

Example 11. A method of constructing an interior vehicle living space, comprising: constructing a vehicle internal support structure assembly comprising: a first frame structure comprising: a left-side frame portion comprising: a first group of interconnected vertically oriented and horizontally oriented longitudinal frame members; a right-side frame portion comprising: a second group of interconnected vertically oriented and horizontally oriented longitudinal frame members; and a top-side frame portion comprising: a third group of interconnected longitudinal frame members; wherein the left-side frame is connected to the top-side frame via a first group of connection members, and wherein the right-side frame is interconnected to the top-side frame via a second group of connection members.

Example 12. The method of any Example 11, further comprising: attaching insulation panels to the support structure assembly.

Example 13. The method of any one of Examples 11-12, further comprising: attaching electrical wiring to the support structure assembly, electrical wiring positioned within channels formed between adjacent insulation panels.

Example 14. The method of any one of Examples 11-13, further comprising attaching wood panels, or panels made from another type of material, to the support structure assembly at rectangular positions formed by intersecting longitudinal frame members.

Example 15. The method of any one of Examples 11-14, further comprising: moving the support structure assembly into an interior cargo area of a vehicle.

Example 16. The method of any one of Examples 11-15, further comprising: attaching one or more of the longitudinal frame members directly to a floor and/or interior walls, and/or other structures of the interior cargo area of the vehicle.

Example 17. The method of any one of Examples 11-16, wherein the support structure assembly is configured with multiple levels of top-side ceiling frame portions to accommodate retraction of a cargo door of the vehicle into the top interior portion of the cargo area.

Example 18. The method of any one of Examples 11-17, further comprising: attaching to one or more longitudinal frame members furniture components.

Example 19. The method of any one of Examples 11-18, wherein the vehicle internal support structure assembly further comprises: a second frame structure comprising: a left-side frame comprising: a first group of interconnected vertically oriented and horizontally oriented longitudinal frame members; a right-side frame comprising: a second group of interconnected vertically oriented and horizontally oriented longitudinal frame members; a top-side frame comprising: a third group of interconnected longitudinal frame members; wherein the left frame is connected to the top frame via a first group of connection members, and wherein the right frame is interconnected to the top frame via a second group of connection members.

Example 20. The method of any one of Examples 11-19, wherein the top-side frame of the second frame structure is positioned higher relative to the top-side frame of the first frame structure.

Example 21. The method of any one of Examples 11-20, wherein a width of the second frame structure is smaller than a width of the first frame structure, the width of the first frame structure being a distance from the left-side frame and the right-side frame of the first frame structure, and the width of the second frame structure being a distance from left-side frame and the right-side frame of the second frame structure.

Example 22. The method of any one of Examples 11-21, wherein the first group of interconnected vertical and horizontal longitudinal frame members, includes at least two vertical longitudinal frame members each having a track with one or more slideable track attachments, and at least two horizontal longitudinal frame members each having a track with one or more slideable track attachments.

Example 23. The method of any one of Examples 11-22, wherein the vehicle internal support structure assembly further comprises: a first furniture component coupled to the at least two horizontal longitudinal frame members, the first furniture component being attachable to one or more locations along the track.

Example 24. The method of any one of Examples 11-23, wherein the vehicle internal support structure assembly further comprises: a plurality of panels coupled to the at least two horizontal longitudinal frame members, the plurality of panels being attachable to one or more locations along the track.

Example 25. The method of any one of Examples 11-24, wherein the vehicle internal support structure assembly further comprises: a plurality of panels coupled to the at least two horizontal longitudinal frame members, the plurality of panels being attachable to one or more locations along the track.

Example 26. The method of any one of Examples 11-25, wherein the vehicle internal support structure assembly further comprises: multiple insulation panels attached to the right-side frame portion and/or the left-side frame portion, wherein attached plurality of insulation panels form a channel between the multiple insulation panels; and electrical wiring positioned within the channel.

Example 27. The method of any one of Examples 11-26, assembly of one of Examples 1-8, wherein one or more of the multiple insulation panels include sections forming a portal or window in the insulation panels.

Example 28. The method of any one of Examples 11-25, wherein the vehicle internal support structure assembly further comprises: a plurality of insulation panels attached to the top-side frame portion.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A vehicle internal support structure assembly, comprising
a first frame structure comprising:
a left-side frame portion comprising:
a first group of interconnected vertically oriented and horizontally oriented longitudinal frame members;
a right-side frame portion comprising:
a second group of interconnected vertically oriented and horizontally oriented longitudinal frame members; and
a top-side frame portion comprising:
a third group of interconnected longitudinal frame members;
wherein the left-side frame is connected to the top-side frame via a first group of connection members, and
wherein the right-side frame is interconnected to the top-side frame via a second group of connection members.

2. The vehicle internal support structure assembly of claim 1, further comprising:
a second frame structure comprising:
a left-side frame comprising:
a first group of interconnected vertically oriented and horizontally oriented longitudinal frame members;
a right-side frame comprising:
a second group of interconnected vertically oriented and horizontally oriented longitudinal frame members;
a top-side frame comprising:
a third group of interconnected longitudinal frame members;
wherein the left frame is connected to the top frame via a first group of connection members, and
wherein the right frame is interconnected to the top frame via a second group of connection members.

3. The vehicle internal support structure assembly of claim 1, wherein the top-side frame of the second frame structure is positioned higher relative to the top-side frame of the first frame structure.

4. The vehicle internal support structure assembly of claim 2, wherein a width of the second frame structure is smaller than a width of the first frame structure, the width of the first frame structure being a distance from the left-side frame and the right-side frame of the first frame structure, and the width of the second frame structure being a distance from left-side frame and the right-side frame of the second frame structure.

5. The vehicle internal support structure assembly of claim 1, wherein
the first group of interconnected vertical and horizontal longitudinal frame members, includes at least two vertical longitudinal frame members each having a track with one or more slideable track attachments, and at least two horizontal longitudinal frame members each having a track with one or more slideable track attachments.

6. The vehicle internal support structure assembly of claim 5, further comprising:
a first furniture component coupled to the at least two horizontal longitudinal frame members, the first furniture component being attachable to one or more locations along the track.

7. The vehicle internal support structure assembly of claim 5, further comprising:
a plurality of panels coupled to the at least two horizontal longitudinal frame members, the plurality of panels being attachable to one or more locations along the track.

8. The vehicle internal support structure assembly of claim 1, further comprising:
multiple insulation panels attached to the right-side frame portion and/or the left-side frame portion, wherein attached plurality of insulation panels form a channel between the multiple insulation panels; and
electrical wiring positioned within the channel.

9. The vehicle internal support structure assembly of claim 8, where one or more of the multiple insulation panels include sections forming a portal or window in the insulation panels.

10. The vehicle internal support structure assembly of claim 1, further comprising:
a plurality of insulation panels attached to the top-side frame portion.

11. A method of constructing an interior vehicle living space, comprising:
constructing a vehicle internal support structure assembly comprising:
a first frame structure comprising:
a left-side frame portion comprising:
a first group of interconnected vertically oriented and horizontally oriented longitudinal frame members;
a right-side frame portion comprising:
a second group of interconnected vertically oriented and horizontally oriented longitudinal frame members; and
a top-side frame portion comprising:
a third group of interconnected longitudinal frame members;
wherein the left-side frame is connected to the top-side frame via a first group of connection members, and
wherein the right-side frame is interconnected to the top-side frame via a second group of connection members.

12. The method of claim 11, further comprising:
attaching insulation panels to the support structure assembly.

13. The method of claim 12, further comprising:
attaching electrical wiring to the support structure assembly, electrical wiring positioned within channels formed between adjacent insulation panels.

14. The method of claim 11, further comprising
attaching panels to the support structure assembly at rectangular positions formed by intersecting longitudinal frame members.

15. The method of claim 11, further comprising:
moving the support structure assembly into an interior cargo area of a vehicle.

16. The method of claim 15, further comprising:
attaching one or more of the longitudinal frame members directly to a floor and/or interior walls, and/or other structures of the interior cargo area of the vehicle.

17. The method of claim 16, wherein the support structure assembly is configured with multiple levels of top-side ceiling frame portions to accommodate retraction of a cargo door of the vehicle into the top interior portion of the cargo area.

18. The method of claim 16, further comprising:
attaching to one or more longitudinal frame members furniture components.
